(19) United States
(12) Patent Application Publication
(10) Pub. No.: US 2023/0270608 A1
(43) Pub. Date: Aug. 31, 2023

(54) Two-way negative pressure isolation passage for fever clinics

(71) Applicants: First Affiliated Hospital of Gannan Medical University, Ganzhou City (CN); First People's Hospital of Longnan City, Ganzhou City (CN)

(72) Inventors: Xiangtai Zeng, Ganzhou City (CN); Yuzhu Lai, Ganzhou City (CN); Guofeng Chen, Ganzhou City (CN); Li Wang, Ganzhou City (CN); Chengcheng Hong, Ganzhou City (CN); Xiong He, Ganzhou City (CN)

(73) Assignees: First Affiliated Hospital of Gannan Medical University, Ganzhou City (CN); First People's Hospital of Longnan City, Ganzhou City (CN)

(21) Appl. No.: 18/097,898

(22) Filed: Jan. 17, 2023

(30) Foreign Application Priority Data
Feb. 25, 2022 (CN) 202210177245.6

(51) Int. Cl. A61G 10/00; A61G 10/02

(52) U.S. Cl. CPC A61G 10/005; A61G 10/023

(57) ABSTRACT

This invention relates to the technical field of isolation passage for fever clinics, and it discloses a two-way negative pressure isolation passage for fever clinics, comprising an inquiry compartment, a dressing room and a doctor passage compartment, wherein, a negative pressure disinfection compartment is arranged between the inquiry compartment and the dressing room, and a negative pressure buffer compartment is arranged between the dressing room and the doctor passage compartment; the isolation passage also comprises a trash conveying compartment arranged below the outer side wall of the inquiry compartment, the dressing room and the doctor's passage compartment, and a bathroom is also arranged in the dressing room. According to the invention, when the medical trash cans in each compartment in the passage need to be conveyed, medical staff only need to convey the trash cans onto the conveying belt through a trash can treatment airtight door while stay in their own area, the trash cans are disinfected for harmless treatment before being conveyed out by negative pressure conveying, which eliminates the need for cleaners to enter dangerous areas to convey trash cans, making protection effect better.

### TECHNICAL FIELD

This invention relates to relates to the technical field of isolation passage for fever clinics, particularly relates to two-way negative pressure isolation passage for fever clinics.

### BACKGROUND

In order to comprehensively implement the series of instructions and deployment given by the CPC Central Committee and the State Council on improving the prevention and treatment ability of the epidemic situations in China, and satisfying the incremental demand of mobile PCR (Covid-19) shelter detection system to meet the requirements of nucleic acid detection under the severe situation of prevention and control of COV-19 pandemic; all hospitals in China must implement the safety measures for fever clinics. At present, the independent isolation passage for fever clinics are an important method to ensure the life and health of medical staff and patients.

China patent CN 112376954 A disclosed a quick disassembly and assembly isolation system for fever clinic, comprising a plurality of passage nits, clinic units and disinfection units that can be assembled with each other. The main structures of the passage unit, the outpatient unit and the disinfection unit all include prefabricated inflatable bags and underframes; the air bag is in the shape of square and tubular when it is inflated, forming a passage for patients or medical staff to pass through, and the two ends of the air bag are provided with openings that communicate with the passage; the passage unit, the outpatient unit and the disinfection unit are spliced and assembled through the openings, and an external sealing adhesive tape is arranged at the splicing position. The described isolation system can be built according to the existing hospital site or corridor path without setting up structures such as foundation or canopy, welding and large-scale construction equipment, which can shorten construction period, and does not occupy space after disassembly; and can also recycle the used material for saving resources.

However, there are still the defects exist in the art described above, which are described as follows:

first, the isolation passage of the fever clinic provided by the above invention is a one-way isolation passage, which is very easy to cause cross infection between medical staff and patients;

moreover, when the medical trash cans in each compartment need to be conveyed and cleaned in the later stage, cleaners need to enter the compartment for conveying the cans, which could cause cross infection, thus not only reducing the safety of the whole isolation passage area, but leads to inconvenience in conveying and cleaning the trash cans.

### SUMMARY

In order to solve the defects described above, this invention provides a two-way negative pressure isolation passage for fever clinics, comprising: an doctor inquiry compartment, a dressing room and a doctor's passage compartment, wherein a negative pressure disinfection compartment is arranged between the inquiry compartment and the dressing room, and a negative pressure buffer compartment is arranged between the dressing room and the doctor's passage compartment; wherein, it also comprises: a trash conveying compartment that is arranged below the outer side wall of the inquiry compartment, the dressing room and the doctor's passage compartment, and a bathroom is also arranged in the dressing room;

wherein, the bottom of the trash conveying compartment is provided with an electrical operation compartment, and a conveyor belt is arranged in the trash conveying compartment; the middle part of that inner cavity of the negative pressure disinfection compartment and the negative pressure buffer compartment are both fixed with a sealing partition plate;

wherein, the walls of the inquiry compartment, the negative pressure disinfection compartment, the dressing room and the negative pressure buffer compartment are all equipped with disinfection atomizing nozzles, and the upper part of the inner cavity of the trash conveying box is fixed with a disinfection spraying long pipe.

As a preferred embodiment of the present invention, a servo motor is fixed on the outer side wall of the trash conveying compartment, the driving end of the servo motor and the driving wheel of the conveyor belt are in power connection with a plurality of equally distributed guide rollers arranged in the trash conveying compartment.

As a preferred embodiment of the present invention, one side of the trash conveying compartment close to the isolation passage is provided with five trash can treatment airtight doors with the same specification, and each trash can treatment airtight doors is respectively communicated with the side walls of the inquiry compartment, the negative pressure disinfection compartment, the dressing room, the negative pressure buffer compartment and the doctor passage compartment, at least one medical trash can is arranged in the inquiry compartment, the negative pressure disinfection compartment, the dressing room, the negative pressure buffer compartment and the doctor's passage compartment.

As a preferred embodiment of the present invention, the bottom of the inquiry compartment, the negative pressure disinfection compartment, the dressing room, the negative pressure buffer compartment, the doctor's passage compartment and the trash conveying compartment are all provided with an electrical operation compartment, a negative pressure pump is arranged in the electrical operation compartment, disinfection air inlets are arranged at the tops of the inquiry compartment, the negative pressure disinfection compartment, the dressing room, the negative pressure buffer compartment, the doctor's passage compartment and the trash conveying compartment, and the exhaust pipe of each negative pressure pump is communicated with a heating purification and sterilization compartment.

As a preferred embodiment of the present invention, isolation wall boards are arranged at both sides of the negative pressure disinfection compartment and the negative pressure buffer compartment, wherein, airtight doors of disinfection compartment and buffer compartment are installed at both sides of isolation wall boards.

As a preferred embodiment of the present invention, the middle parts of the negative pressure disinfection compartment and the negative pressure buffer compartment are both provided with sealing partition plates, tempered glass is fixedly embedded in the middle part of the sealing partition plate, and the front and rear side walls of the tempered glass are respectively fixed with communication speakers for signal transmission.

As a preferred embodiment of the present invention, a patient-end airtight door and a doctor-end airtight door are respectively installed at the entrance of the inquiry compartment and the doctor's passage compartment; the atmospheric pressure values of the inquiry compartment, negative pressure disinfection compartment, dressing room, negative pressure buffer compartment and doctor's passage compartment are −20 pa, −10 pa, −10 pa and −20 pa respectively.

Compared with the prior art, this invention has the following beneficial effects:

according to this invention, when the medical trash cans in each compartment in the passage need to be conveyed, medical staff only need to convey the trash cans onto the conveying belt through a trash can treatment airtight door while stay in their own area, the trash cans are disinfected for harmless treatment before being conveyed out by negative pressure conveying, which eliminates the need for cleaners to enter dangerous areas to convey trash cans, making protection effect better;

according to this invention, two airtight doors of the negative-pressure disinfection compartment and the negative-pressure buffer compartment are opened step by step to form a buffer zone, which can optimize the air under the negative-pressure condition to avoid the leakage of viruses.

The middle of the negative pressure compartment and the negative pressure buffer compartment are both installed with sealing partition plates, and tempered glass is fixedly embedded in the middle of the sealing partition plates. The front and rear side walls of the tempered glass are respectively fixed with call speakers for signal transmission. The sealing partition plates can divide the whole compartment into two-way passage, which does not affect the doctor's entrance and exit. Moreover, this design is very convenient for medical staffs who enters and exits in a specific area to communicate with each other through the call speakers.

### BRIEF DESCRIPTION OF DRAWINGS

Other features, objects and advantages of the present invention will become more apparent by reading the detailed description of the non-limiting embodiments with reference to the following drawings:

FIG. 1 is a front view of a bidirectional negative pressure isolation passage for fever clinic of the present invention;

FIG. 2 is a schematic cross-sectional structure of a bidirectional negative pressure isolation passage for fever clinic of the present invention;

FIG. 3 is a schematic view of the overall side sectional structure of a bidirectional negative pressure isolation passage for fever clinic of the present invention;

FIG. 4 is a schematic side view of a bidirectional negative pressure isolation passage for fever clinic of the present invention;

FIG. 5 is a schematic diagram of the distribution structure of the conveyor belt of a two-way negative pressure isolation passage for a fever clinic in the trash conveying compartment;

FIG. 6 is a schematic diagram of the connection structure between a heating purification and sterilization box and a negative pressure pump of a two-way negative pressure isolation channel for a fever clinic.

FIG. 7 is a schematic structural diagram of a cross-section of an inquiry compartment of a two-way negative pressure isolation passage for fever clinic.

Description of reference numerals in the Figures:

1. inquiry compartment; 2. negative pressure disinfection compartment; 3. dressing room; 4. negative pressure buffer compartment; 5. doctor's passage compartment; 6. trash conveying compartment; 7. disinfection atomizing nozzles; 8. doctor end airtight door; 9. electrical operation compartment; 10, negative pressure pump; 11. trash treatment airtight door; 12. buffer compartment airtight door; 13. servo motor; 14. disinfecting wardrobe; 15. disinfection compartment airtight door; 16. conveyor belt; 17. airtight door for picking and placing; 18. medical trash cans; 19. disinfecting and washing basin; 20, patient end airtight door; 21. sealing partition plate; 22. disinfection air inlet; 23. disinfection spray long pipe; 24. ultraviolet disinfection lamp; 25. guide roller; 26. heating purification and sterilization box; 27. tempered glass; 28. speaker.

### DETAILED DESCRIPTION OF EMBODIMENTS

In order to make the technical means, creative features, objectives and effects of the present invention easy to understand, the present invention will be further explained with reference to specific embodiments.

In the description of the present invention, it should be understood that the directions or positional relationships indicated by the terms “up”, “down”, “front”, “back”, “left”, “right”, “top”, “bottom”, “inside” and “outside” are based on the directions or positional relationships shown in the drawings, only for convenience and simplification of the description of the present invention.

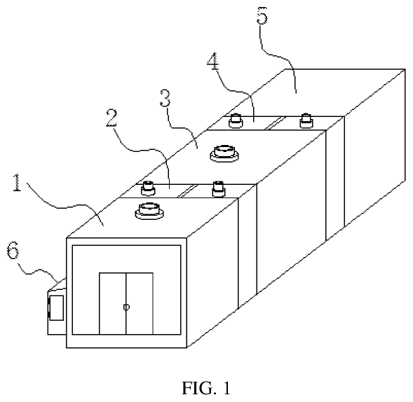

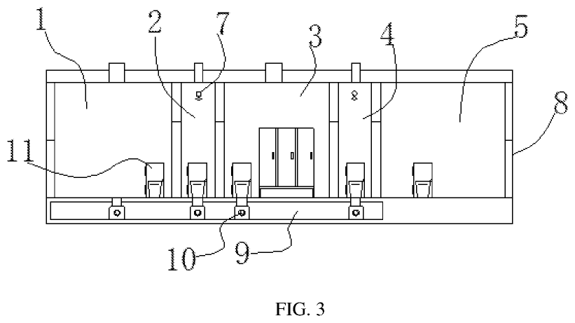

Referring to FIGS. 1-7, this invention provides a two-way negative pressure isolation passage for fever clinics, comprising:

a inquiry compartment 1, a dressing room 3 and a doctor's passage compartment 5, wherein a negative pressure disinfection compartment 2 is arranged between the inquiry compartment 1 and the dressing room 3, and a negative pressure buffer compartment 4 is arranged between the dressing room 3 and the doctor's passage compartment 5. The negative pressure disinfection compartment 2 is used for medical staff for disinfection when they actually return to the dressing room 3, and the virus can not be carried under the negative pressure; moreover, a two-way negative pressure isolation passage for fever clinics; also comprising: a trash conveying compartment 6 arranged below the outer side wall of the inquiry compartment 1, the dressing room 3 and the doctor's passage compartment 5, and the trash conveying compartment 6 can carry out harmless conveying treatment on trash cans in each compartment of the negative pressure isolation passage; wherein, the bottom of the trash conveying compartment 6 is provided with an electrical operation compartment 9, and the trash conveying compartment 6 is internally provided with a conveying belt 16; a sealing partition plate 21 is fixed at the middle of the inner cavity of the negative pressure disinfection compartment 2 and the negative pressure buffer compartment 4; disinfection atomizing nozzles 7 are installed on the top of the walls of the inquiry compartment 1, negative pressure disinfection compartment 2, dressing room 3 and negative pressure buffer compartment 4, and a long disinfection spray pipe 23 is fixed on the upper part of the inner cavity of the trash conveying box 6. The long disinfection spray pipe 23 can carry out disinfection and harmless treatment on the garbage conveying compartment 6 after each trash conveying.

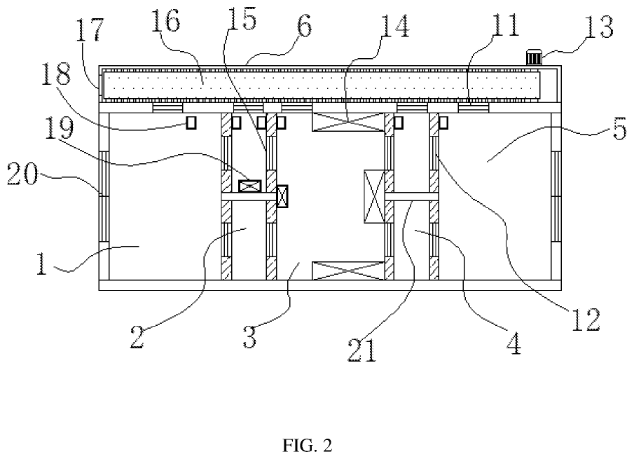

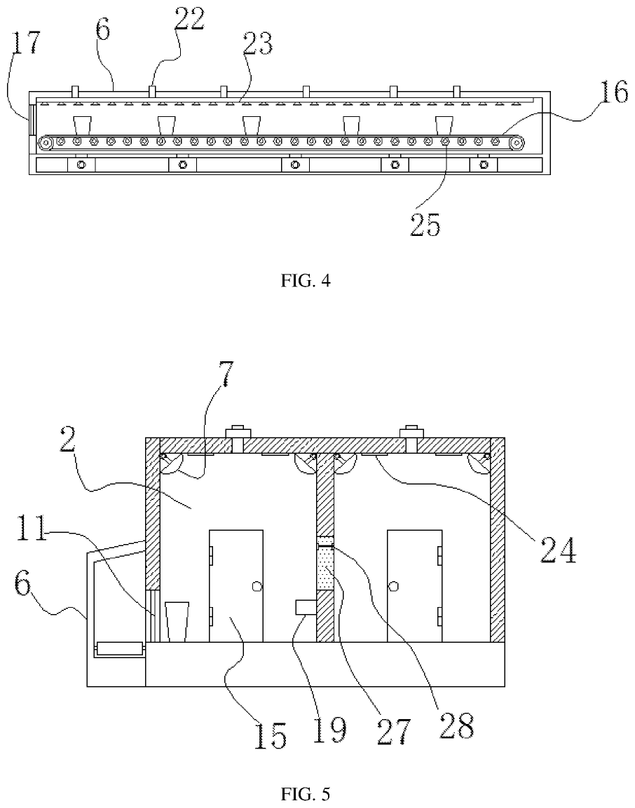

Referring to FIGS. 2 and 4, in the specific embodiment, the servo motor 13 is fixed on the outer side wall of the trash conveying compartment 6, the driving end of the servo motor 13 is in power connection with the driving wheel of the conveyor belt 16, and a plurality of equally distributed guide rollers 25 are installed in the garbage conveying compartment 6. Each guide roller 25 is attached to the conveyor belt 16. When the medical trash can 18 needs to be conveyed, the servo motor 13 drives the conveyor belt 16 to start conveying, and the guide roller 25 can bear and guide the conveyor belt 16 to ensure the stable conveying of the trash can. The trash can treatment airtight door 11 is installed at the front end of the trash conveying compartment 6, and the disinfection spraying long pipe 23 at the upper part of the inner cavity of the trash conveying compartment 6 sprays disinfection during the conveying process, thus harmlessly treating the trash conveying compartment 6.

Referring to FIGS. 2 and 4. Furthermore, five trash treatment airtight doors 11 with the same specification are set on one side of the trash delivery compartment 6 near the isolation passage, and each trash treatment airtight door 11 is connected with the side walls of the inquiry compartment 1, the negative pressure disinfection compartment 2, the dressing room 3, the negative pressure buffer compartment 4 and the doctor passage compartment 5, therefore, medical staff can directly transfer the medical trash cans 18 to the conveyor belt 16 in the trash delivery compartment 6 through the trash treatment airtight door 11 in their own area.

At least one medical trash can 18 is arranged in the inquiry compartment 1, the negative pressure disinfection compartment 2, the dressing room 3, the negative pressure buffer compartment 4 and the doctor's passage compartment 5, and medical staff can put the generated medical trash into the medical trash can 18 for harmless treatment. A patient-end airtight door 20 and a doctor-end airtight door 8 are respectively installed at the entrance of the inquiry compartment 1 and the doctor's passage compartment 5; the length of the long spraying pipe 23 is equal to the length of the conveyor belt 16, which ensures that the disinfectant sprayed from the long spraying pipe 23 can cover the whole inner cavity of the trash conveying compartment 6, also for it to be fully disinfected; the ultraviolet disinfection lamp 24 is installed at the top of the inner cavity of the inquiry compartment 1, negative pressure disinfection compartment 2, dressing room 3 and negative pressure buffer compartment 4.

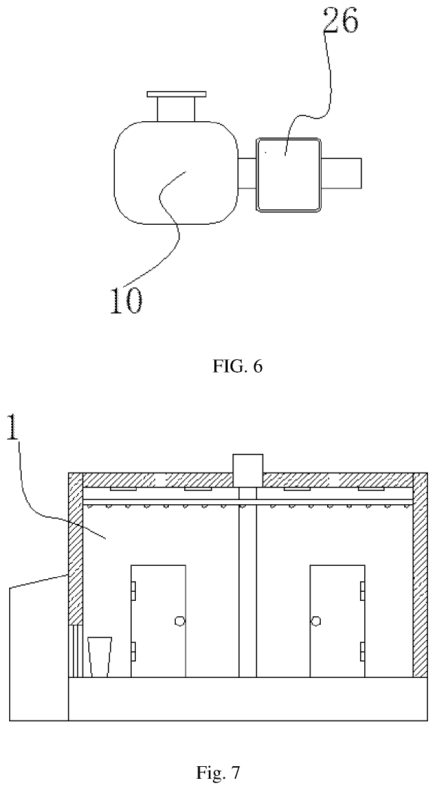

Referring to FIGS. 2 and 6. Furthermore, the bottom of the inquiry compartment 1, the negative pressure disinfection compartment 2, the dressing room 3, the negative pressure buffer compartment 4, the doctor's passage compartment 5 and the trash conveying compartment 6 are all provided with an electrical operation compartment 9. The bottom plate laid on the upper part of the electrical operation compartment 9 can be removed, which is convenient for maintenance personnel to enter the electrical operation compartment 9 for maintenance.

A negative pressure pump 10 is arranged in the electrical operation compartment 9, and disinfection air inlets 22 are arranged at the tops of the inquiry compartment 1, the negative pressure disinfection compartment 2, the dressing room 3, the negative pressure buffer compartment 4, the doctor's passage compartment 5 and the trash conveying compartment 6, in order to preliminarily sterilize and filter the air entering the passage. The exhaust pipe of each negative pressure pump 10 is connected with a heating purification and sterilization compartment 26, which performs high-temperature sterilization and disinfection on the air discharged by negative pressure.

Referring to FIGS. 2 and 5. Furthermore, the two sides of the isolation wall boards located at the two sides of the negative pressure disinfection compartment 2 and the negative pressure buffer compartment 4 are respectively provided with disinfection compartment airtight doors 15 and buffer compartment airtight doors 12, and the two airtight doors of the negative pressure disinfection compartment 2 and the negative pressure buffer compartment 4 are opened step by step to form a buffer zone.

The atmospheric pressure values of the consultation compartment 1, negative pressure disinfection compartment 2, dressing room 3, negative pressure buffer compartment 4 and doctor's passage compartment (5) are −20 pa, −10 pa, −15 pa, −10 pa and −20 pa respectively. The multi-step modulation type of negative pressure environment can ensure the cleanliness and stability of the clean area. Under negative pressure, the air can be optimized to avoid the virus from leaking out. The middle of the negative pressure disinfection compartment 2 and the negative pressure buffer compartment 4 are installed with sealing partition plates 21, tempered glass 27 is fixedly embedded in the sealing partition plates, and the front and rear side walls of the tempered glass 27 are respectively fixed with communication speakers 28 for signal transmission. The sealing partition plates 21 can divide the whole passage into two-way passage, which does not affect the entrance and exit of doctors. Moreover, it is very convenient for medical staff who enters and exits in a specific area to communicate with each other through the speaker 28. This speaker 28 is the customer speaker on the normal bank counter system, which can avoid the spread of viruses.

Referring to FIGS. 2 and 5. Furthermore, a disinfection and washing basin 19 is fixed at the lower middle of the rear side of the tempered glass 27 in the negative pressure disinfection compartment 2. The medical staff can perform disinfection and washing after entering the negative pressure disinfection compartment 2, in where the used protective gown can be undressed and thrown into the medical trash can 18, and the disinfection and washing basin 19 is for disinfection. A plurality of groups of disinfection wardrobes 14 are arranged in the dressing room 3, and the wardrobes 14 can disinfect clothes exchanged by medical staff.

It should be noted that the present invention is a two-way negative pressure isolation channel for fever clinic, all parts are general standard parts or parts known to the skilled person, and its structure and principle are all known to the skilled person through technical manuals or conventional experimental methods.

Working principle of the present invention: open the doctor end airtight door 8 on the doctor's passage compartment 5 to enter the compartment, then open the first buffer compartment airtight door 12 in the direction of the entrance of the dressing room 3, then after entering the negative pressure buffer compartment 4, open the second buffer airtight door 12 and enter the dressing room 3 to change clothes. After changing clothes, open the first disinfection compartment airtight door 15 from the entrance of the negative pressure disinfection compartment 2,

after entering the negative-pressure disinfection compartment 2, open the second disinfection compartment airtight door 15, and then enter the inquiry compartment 1 for consultation. After inquiry is done, open the first disinfection compartment airtight door 15 of the negative-pressure disinfection compartment 2 through the returning passage, and enter the negative-pressure disinfection compartment 2. Under the negative-pressure condition, take off their protective masks and protective gown first, then, take off the medical gloves, wash and disinfect on the disinfection and washing basin 19, and spray and disinfect under the condition of disinfection atomizing nozzles 7. Finally, open the second disinfection compartment airtight door 15, enter the dressing room 3, wash and change clothes.

When it is necessary to transfer the medical trash cans 18 in each compartment in the passage, it is only necessary to open the trash can treatment airtight door 11, the medical trash can 18 can be directly conveyed to the conveyor belt 16 in the garbage delivery compartment 6 through the trash can treatment airtight door 11 in the same own area, and then carry out the harmless treatment. At least one medical trash can 18 is arranged in the consultation compartment 1, the negative pressure disinfection compartment 2, the dressing room 3, the negative pressure buffer compartment 4 and the doctor's passage compartment 5, and the generated medical trash can be put into the medical garbage can 18 for harmless treatment; Before the conveyor belt 16 runs, the disinfectant sprayed from the disinfection spray long pipe 23 can cover the entire inner cavity of the trash conveying compartment 6, and after the disinfection is completed, the conveyor belt 16 is started, and the negative pressure system of the cash conveying compartment 6 is also started to work, ensuring the harmless transfer of the medical trash can 18, without the need for cleaners to enter dangerous areas to transfer the garbage can, making a better the protection effect.

Having shown and described the basic principles, main features and advantages of the present invention, it is obvious to those skilled in the art that the present invention is not limited to the details of the above exemplary embodiments, but can be implemented in other specific forms without departing from the spirit or basic features of the present invention. Therefore, the embodiments should be regarded as illustrative and non-restrictive in all respects. The scope of the invention is defined by the appended claims rather than the above description, and therefore all changes that fall within the meaning and range of equivalents of the claims are intended to be embraced by the invention. Any reference signs in the claims should not be regarded as limiting the claims involved.

In addition, it should be understood that although this specification is described in terms of embodiments, not every embodiment only contains an independent technical solution. This description of the specification is only for the sake of clarity. Those skilled in the art should take the specification as a whole, and the technical solutions in each embodiment can also be appropriately combined to form other embodiments that can be understood by those skilled in the art.

What is claimed is:

1. A two-way negative pressure isolation passage for fever clinics, comprising: an doctor inquiry compartment (1), a dressing room (3) and a doctor's passage compartment (5), wherein a negative pressure disinfection compartment (2) is arranged between the inquiry compartment (1) and the dressing room (3), and a negative pressure buffer compartment (4) is arranged between the dressing room (3) and the doctor's passage compartment (5); wherein, it also comprises: a trash conveying compartment (6) that is arranged below the outer side wall of the inquiry compartment (1), the dressing room (3) and the doctor's passage compartment (5), and a bathroom is also arranged in the dressing room (3);
wherein, the bottom of the trash conveying compartment (6) is provided with an electrical operation compartment (9), and a conveyor belt (16) is arranged in the trash conveying compartment (6); the middle part of that inner cavity of the negative pressure disinfection compartment (2) and the negative pressure buffer compartment (4) are both fixed with a sealing partition plate (21);
wherein, the walls of the inquiry compartment (1), the negative pressure disinfection compartment (2), the dressing room (3) and the negative pressure buffer compartment (4) are all installed with disinfection atomizing nozzles (7), and the upper part of the inner cavity of the trash conveying box (6) is fixed with a disinfection spraying long pipe (23).

2. The two-way negative pressure isolation passage for fever clinics as claimed in claim 1, a servo motor (13) is fixed on the outer side wall of the trash conveying compartment (6), the driving end of the servo motor (13) and the driving wheel of the conveyor belt (16) are in power connection with a plurality of equally distributed guide rollers (25) arranged in the trash conveying compartment.

3. The two-way negative pressure isolation passage for fever clinics as claimed in claim 1, one side of the trash conveying compartment (6) close to the isolation passage is provided with five trash can treatment airtight doors (11) with the same specification, and each trash can treatment airtight doors (11) is respectively communicated with the side walls of the inquiry compartment (1), the negative pressure disinfection compartment (2), the dressing room (3), the negative pressure buffer compartment (4) and the doctor passage compartment (5), at least one medical trash can (18) is arranged in the inquiry compartment (1), the negative pressure disinfection compartment (2), the dressing room (3), the negative pressure buffer compartment (4) and the doctor's passage compartment (5).

4. The two-way negative pressure isolation passage for fever clinics as claimed in claim 1, the bottom of the inquiry compartment (1), the negative pressure disinfection compartment (2), the dressing room (3), the negative pressure buffer compartment (4), the doctor's passage compartment (5) and the trash conveying compartment (6) are all provided with an electrical operation compartment (9), a negative pressure pump (10) is arranged in the electrical operation compartment (9), disinfection air inlets (22) are arranged at the tops of the inquiry compartment (1), the negative pressure disinfection compartment (2), the dressing room (3), the negative pressure buffer compartment (4), the doctor's passage compartment (5) and the trash conveying compartment (6), and the exhaust pipe of each negative pressure pump (10) is communicated with a heating purification and sterilization compartment (26).

5. The two-way negative pressure isolation passage for fever clinics as claimed in claim 1, isolation wall boards are arranged at both sides of the negative pressure disinfection compartment (2) and the negative pressure buffer compartment (4), wherein, airtight doors of disinfection compartment (15) and buffer compartment are installed at both sides of isolation wall boards.

6. The two-way negative pressure isolation passage for fever clinics as claimed in claim 1, the middle parts of the negative pressure disinfection compartment (2) and the negative pressure buffer compartment (4) are both provided with sealing partition plates (21), tempered glass (27) is fixedly embedded in the middle part of the sealing partition plate (21), and the front and rear side walls of the tempered glass (27) are respectively fixed with communication speakers (28) for signal transmission.

7. The two-way negative pressure isolation passage for fever clinics as claimed in claim 6, a disinfection and washing basin (19) is fixed at the lower middle of the rear side of tempered glass (27) in the negative pressure disinfection compartment (2); a plurality of groups of disinfection wardrobes (14) are arranged in the dressing room (3).

8. The two-way negative pressure isolation passage for fever clinics as claimed in claim 1, a patient-end airtight door (20) and a doctor-end airtight door (8) are respectively installed at the entrance of the inquiry compartment (1) and the doctor's passage compartment (5); the atmospheric pressure values of the inquiry compartment (1), negative pressure disinfection compartment (2), dressing room (3), negative pressure buffer compartment (4) and doctor's passage compartment (5) are −20 pa, −10 pa, −10 pa and −20 pa respectively.

9. The two-way negative pressure isolation passage for fever clinics as claimed in claim 1, the length of the disinfection spray long pipe (23) is equal to that of the conveyor belt (16); ultraviolet disinfection lamps (24) are installed at the top of the inner cavity of the inquiry compartment (1), negative pressure disinfection compartment (2), dressing room (3) and negative pressure buffer compartment (4).
